(19) United States
(12) Patent Application Publication
(10) Pub. No.: US 2008/0165185 A1
(43) Pub. Date: Jul. 10, 2008

(54) Systems and methods for selectively imaging objects in a display of multiple three-dimensional data-objects

(75) Inventors: Stuart Smith, Englewood, CO (US); Donald Murray, Golden, CO (US)

Correspondence Address: CRAIN, CATON & JAMES, FIVE HOUSTON CENTER, 1401 MCKINNEY, 17TH FLOOR, HOUSTON, TX, 77010, US

(73) Assignee: Landmark Graphics Corporation, a Halliburton Company, Houston, TX (US)

(21) Appl. No.: 12/006,702

(22) Filed: Jan. 4, 2008

Related U.S. Application Data
(60) Provisional application No. 60/883,711, filed on Jan. 5, 2007.

(51) Int. Cl. G06T 15/00

(52) U.S. Cl. 345/419

(57) ABSTRACT

Systems and methods for selectively imaging objects in a display of multiple three-dimensional data-objects. Further features include the display of objects and the intersection of objects removed from the display with various types of visualization surfaces for removing data that obstructs the display of objects of interest.

### CROSS REFERENCE TO RELATED APPLICATIONS

The priority of U.S. Provisional Patent Application No. 60/883,711, filed on Jan. 5, 2007, is hereby claimed, and the specification thereof is incorporated herein by reference.

### STATEMENT REGARDING FEDERALLY SPONSORED RESEARCH OR DEVELOPMENT

Not applicable.

### FIELD OF THE INVENTION

The present invention generally relates to systems and methods for selectively imaging objects in a display of multiple three-dimensional data-objects, which include objects of interest such as, for example, horizons, reservoir grids and well paths.

### BACKGROUND OF THE INVENTION

In some fields, it is useful to model objects in two or three dimensions. Modeling such objects proves useful in a variety of applications. For example, modeling the subsurface structure of a portion of the earth's crust is useful for finding oil deposits, locating fault lines and in other geological applications. Similarly, modeling human body parts is useful for medical training exercises, diagnoses, performing remote surgery or for other medical applications. The foregoing objects are exemplary only, and other fields may likewise find utility in modeling objects.

In the field of earth sciences, seismic sounding is used for exploring the subterranean geology of an earth formation. An underground explosion excites seismic waves, similar to low-frequency sound waves that travel below the surface of the earth and are detected by seismographs. The seismographs record the time of arrival of seismic waves, both direct and reflected. Knowing the time and place of the explosion, the time of travel of the waves through the interior can be calculated and used to measure the velocity of the waves in the interior. A similar technique can be used for offshore oil and gas exploration. In offshore exploration, a ship tows a sound source and underwater hydrophones. Low frequency, (e.g., 50 Hz) sound waves are generated by, for example, a pneumatic device that works like a balloon burst. The sounds bounce off rock layers below the sea floor and are picked up by the hydrophones. In either application, subsurface sedimentary structures that trap oil, such as faults and domes are mapped by the reflective waves.

In the medical field, a computerized axial topography (CAT) scanner or magnetic resonance imaging (MRI) device is used to collect information from inside some specific area of a person's body. Such modeling can be used to explore various attributes within an area of interest (for example, pressure or temperature).

The data is collected and processed to produce three-dimensional volume data sets. A three-dimensional volume data set, for example, may be made up of “voxels” or volume elements, whereby each voxel may be identified by the x, y, z coordinates of one of its eight corners or its center. Each voxel also represents a numeric data value (attribute) associated with some measured or calculated physical property at a particular location. Examples of geological data values include amplitude, phase, frequency, and semblance. Different data values are stored in different three-dimensional volume data sets, wherein each three-dimensional volume data set represents a different data value.

Graphical displays allow for the visualization of vast amounts of data, such as three-dimensional volume data sets, in a graphical representation. However, displays of large quantities of data may create a cluttered image or an image in which a particular object of interest is partially obscured by undesirable data or other objects. There is therefore, a need to restrict the data displayed to the objects of interest.

One conventional solution requires the selective deletion of particular objects that are blocking the view of an object of interest or cluttering the display of graphical data. There are disadvantages associated with this solution, which include significant time consumption and the required deletion of an entire object without any spatial point of reference to determine where the deleted object was located relative to the object of interest. A more efficient and selective technique is needed, which will allow the selective removal of undesirable data or other objects without having to individually select and remove each displayed object in its entirety. Such a technique should therefore, enable the selective removal of undesirable data or other objects without removing a spatial point of reference.

Another approach is described in U.S. Pat. No. 6,765,570 (the “'570 Patent”), which is assigned to Landmark Graphics Corporation and incorporated herein by reference. This patent describes a system and method for analyzing and imaging three-dimensional volume data sets using a three-dimensional sampling probe. The sampling probe can be created, shaped, and moved interactively by the user within the entire three-dimensional volume data set. As the sampling probe changes shape, size or location in response to user input, an image representing an intersection of the sampling probe and the three-dimensional volume data set is re-drawn at a rate sufficiently fast to be perceived in real-time by the user. In this manner, the user can achieve real-time interactivity by limiting the display of the three-dimensional volume data set to an image of an intersection of the sampling probe and the three-dimensional volume data set.

Although the '570 Patent describes a method for limiting the display of the three-dimensional volume data set, the sampling probe, as a visualization surface, cannot limit the display to an image of an intersection between the object(s) and the sampling probe—much less complex objects encountered in the oil and gas industry like a reservoir grid. In other words, the sampling probe, as a visualization surface, displays an image of an intersection of the sampling probe, the three-dimensional volume data set and the object(s). As a result, the image of the intersection of the sampling probe and the three-dimensional volume data set detracts/distracts from the image of the intersection between the object(s) and the sampling probe.

As such, there is a need for selectively removing undesirable data or other objects from a display of multiple three-dimensional data-objects, without having to individually select and remove each object, while maintaining a spatial point of reference with respect to the undesired object(s) removed from the display relative to the remaining object(s) in the display.

### SUMMARY OF THE INVENTION

The present invention therefore, meets the above needs and overcomes one or more deficiencies in the prior art by providing systems and methods for selectively imaging objects in a display of multiple three-dimensional data-objects.

In one embodiment, the present invention includes a method for selectively imaging one or more objects in a display that comprises i) defining a visualization surface within the display; ii) selecting an object of interest from the plurality of objects within the display; and iii) displaying only an image of an intersection between at least one of the plurality of objects removed from the display and the visualization surface and an image of the object(s) remaining in the display or an image of an intersection between the remaining object(s) and the visualization surface.

In another embodiment, the present invention includes a computer-readable medium having computer executable instructions for selectively imaging one or more objects in a display. The instructions are executable to implement i) defining a visualization surface within the display; ii) selecting an object of interest from the plurality of objects within the display; and iii) displaying only an image of an intersection between at least one of the plurality of objects removed from the display and the visualization surface and an image of the remaining object(s) in the display or an image of an intersection between the remaining object(s) and the visualization surface.

In another embodiment, the present invention includes a method for selectively imaging one or more objects in a display that comprises i) defining a visualization surface within the display; ii) selecting an object of interest from a plurality of objects within the display, at least one of the plurality of objects comprising a reservoir grid; and iii) displaying an image of an intersection between the reservoir grid and the visualization surface and an image of the object(s) remaining in the display or an image of an intersection between the remaining object(s) and the visualization surface.

In another embodiment, the present invention includes a computer-readable medium having computer executable instructions for selectively imaging one or more objects in a display. The instructions are executable to implement i) defining a visualization surface within the display; ii) selecting an object of interest from a plurality of objects within the display; and iii) displaying an image of an intersection between the reservoir grid and the visualization surface and an image of the object(s) remaining in the display or an image of an intersection between the remaining object(s) and the visualization surface.

In another embodiment, the present invention includes platform for selectively imaging one or more objects in a display that is embodied on one or more computer readable media and executable on a computer that comprises i) a user input module for accepting user inputs related to defining a visualization surface within the display and selecting an object of interest from a plurality of objects within the display; ii) a visualization surface module for processing a set of instructions to determine an intersection between at least one of the plurality of objects removed from the display and the visualization surface and an intersection between the object(s) remaining in the display and the visualization surface; and iii) a rendering module for displaying only an image of an intersection between the at least one of the plurality of objects removed from the display and the visualization surface and an image of the object(s) remaining in the display or an image of an intersection between the remaining object(s) and the visualization surface.

In another embodiment, the present invention includes a platform for selectively imaging one or more objects in a display that is embodied on one or more computer readable media and executable on a computer that comprises i) a user input module for accepting user inputs related to defining a visualization surface within the display and selecting an object of interest from a plurality of objects within the display, at least one of the plurality of objects comprising a reservoir grid; ii) a visualization surface module for processing a set of instructions to determine an intersection between the reservoir grid and the visualization surface and an intersection between the object(s) remaining in the display and the visualization surface; and iii) a rendering module for displaying an image of an intersection between the reservoir grid and the visualization surface and an image of the object(s) remaining in the display or an image of an intersection between the remaining object(s) and the visualization surface.

Additional aspects, advantages and embodiments of the invention will become apparent to those skilled in the art from the following description of the various embodiments and related drawings.

### BRIEF DESCRIPTION OF THE DRAWINGS

The patent or application file contains at least one drawing executed in color.

Copies of this patent or patent application publication with color drawing(s) will be provided by the Office upon request and payment of the necessary fee.

The invention will be described with reference to the accompanying drawings, in which like elements are referenced with like reference numerals, and in which:

FIG. 1 is a block diagram illustrating one embodiment of a software program for implementing the present invention.

FIG. 2 is a flow diagram illustrating one embodiment of a method for implementing the present invention.

FIG. 3 is a color drawing illustrating a display of multiple three-dimensional data-objects comprising a well path, horizons, reservoir grids and three three-dimensional seismic-data slices.

FIG. 4 is a color drawing illustrating the well path in FIG. 3 and an intersection between the remaining objects in FIG. 3 and the three three-dimensional seismic-data slices that represent three separate visualization surfaces.

FIG. 5 is a color drawing illustrating another perspective of the display in FIG. 4 after each visualization surface is repositioned.

FIG. 6 is a color drawing illustrating another perspective of the display in FIG. 4 after each visualization surface is repositioned and a new visualization surface is added.

FIG. 7 is a color drawing illustrating another perspective of the display in FIG. 6 after the visualization surfaces in FIG. 5 are removed and another visualization surface is added.

### DETAILED DESCRIPTION OF THE PREFERRED EMBODIMENTS

The subject matter of the present invention is described with reference to certain preferred embodiments however, is not intended to limit the scope of the invention. The claimed subject matter thus, might also be embodied in other ways to include different steps, or combinations of steps, similar to the ones described herein and other technologies. Although the term “step” may be used herein to connote different elements of methods employed, the term should not be interpreted as implying any particular order among or between various steps herein disclosed unless otherwise expressly limited by the description to a particular order.

In one embodiment, the present invention may be described in the general context of a computer-executable program of instructions, such as program modules, generally referred to as software. The software may include, for example, routines, programs, objects, components, data structures, etc., that perform particular tasks or implement particular abstract data types. The software forms an interface to allow a computer to react according to a source of input. The software may also cooperate with other code segments to initiate a variety of tasks in response to data received in conjunction with the source of the received data. The software may be stored onto any variety of memory media such as CD-ROM, magnetic disk, bubble memory and semiconductor memory (e.g., various types of RAM or ROM). Furthermore, the software and results may be transmitted over a variety of carrier media such as optical fiber, metallic wire, free space and/or through any of a variety of networks such as the internet.

Those skilled in the art will appreciate that the present invention may be implemented in a variety of computer-system configurations including hand-held devices, multiprocessor systems, microprocessor-based or programmable-consumer electronics, minicomputers, mainframe computers and the like. Any number of computer-systems and computer networks are therefore, acceptable for use with the present invention. The present invention may be practiced in distributed-computing environments where tasks are performed by remote-processing devices that are linked through a communications network. In a distributed-computing environment, the software may be located in both local and remote computer-storage media including memory storage devices.

The present invention may therefore, be implemented using hardware, software or a combination thereof, in a computer system or other processing system.

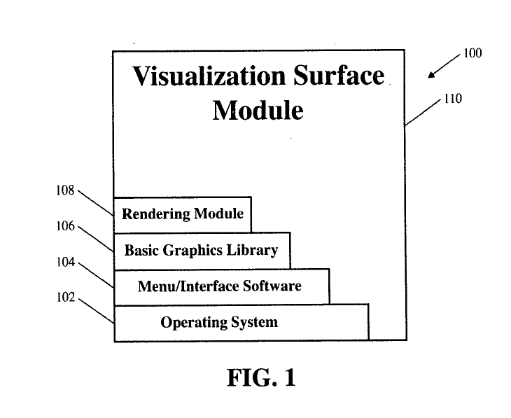

FIG. 1 is a block diagram illustrating one embodiment of a software program 100 for the present invention. At the base of the program 100 is an operating system 102. A suitable operating system 102 may include, for example, a Windows® operating system from Microsoft Corporation, or other operating systems as would be apparent to one of skill in the relevant art.

Menu/interface software 104 overlays the operating system 102. The menu/interface software 104 are used to provide various menus and windows to facilitate interaction with the user, and to obtain user input and instructions. As would be readily apparent to one of skill in the relevant art, any number of menu/interface software programs could be used in conjunction with the present invention.

A basic graphics library 106 overlays menu/interface software 104. Basic graphics library 106 is an application programming interface (API) for three-dimensional computer graphics. The functions performed by basic graphics library 106 may include, for example, geometric and raster primitives, RGBA or color index mode, display list or immediate mode, viewing and modeling transformations, lighting and shading, hidden surface removal, alpha blending (translucency), anti-aliasing, texture mapping, atmospheric effects (fog, smoke, haze), feedback and selection, stencil planes and accumulation buffer.

A particularly useful basic graphics library 106 is OpenGL®, marketed by Silicon Graphics, Inc. (“SGI®”). The OpenGL® API is a multi-platform industry standard that is hardware, window and operating system independent. OpenGL® is designed to be callable from C, C++, FORTRAN, Ada and Java programming languages. OpenGL® performs each of the functions listed above for basic graphics library 106. Some commands in OpenGL® specify geometric objects to be drawn, and others control how the objects are handled. All elements of the OpenGL® state, even the contents of the texture memory and the frame buffer, can be obtained by a client application using OpenGL®. OpenGL® and the client application may operate on the same or different machines because OpenGL® is network transparent. OpenGL® is described in more detail in the OpenGL® Programming Guide (ISBN: 0-201-63274-8) and the OpenGL® Reference Manual (ISBN: 0-201-63276-4), both of which are incorporated herein by reference.

A rendering module 108 overlays basic graphics library 106. The rendering module 108 is an API for creating real-time, multi-processed three-dimensional visual simulation graphics applications. As will be understood by those skilled in the art, the rendering module 108 may include a suite of tools for two-dimensional and/or three-dimensional seismic data interpretations including, for example, interactive horizon and fault management, three-dimensional visualization and attribute analysis. The rendering module 108 therefore, provides functions that bundle together graphics library state control functions such as lighting, materials, texture, and transparency. These functions track state and the creation of display lists that can be rendered later. Asset View™, which is a commercial-software package marketed by Landmark Graphics Corporation for use in the oil and gas industry, is one example of an appropriate rendering module for use with the present invention.

Another example of an appropriate rendering module is OpenGL Performer®, which is available from SGI®. OpenGL Performer® supports the OpenGL® graphics library discussed above. OpenGL Performer® includes two main libraries (libpf and libpr) and four associated libraries (libpfdu, libpfdb, libpfui and libpfutil).

The basis of OpenGL Performer® is the performance rendering library libpr, a low-level library providing high speed rendering functions based on GeoSets and graphics state control using GeoStates. GeoSets are collections of drawable geometry that group same-type graphics primitives (e.g., triangles or quads) into one data-object. The GeoSet contains no geometry itself, only pointers to data arrays and index arrays. Because all the primitives in a GeoSet are of the same type and have the same attributes, rendering of most databases is performed at maximum hardware speed. GeoStates provide graphics state definitions (e.g., texture or material) for GeoSets.

Layered above libpr is libpf, a real-time visual simulation environment providing a high-performance multi-process database rendering system that optimizes use of multiprocessing hardware. The database utility library, libpfdu, provides functions for defining both geometric and appearance attributes of three-dimensional objects, shares state and materials, and generates triangle strips from independent polygonal input. The database library libpfdb uses the facilities of libpfdu, libpf and libpr to import database files in a number of industry standard database formats. The libpfui is a user interface library that provides building blocks for writing manipulation components for user interfaces (C and C++ programming languages). Finally, the libpfutil is the utility library that provides routines for implementing tasks and graphical user interface (GUI) tools.

An application program which uses OpenGL Performer® and OpenGL® API typically performs the following steps in preparing for real-time three-dimensional visual simulation:
1. Initialize OpenGL Performer®;
2. Specify number of graphics pipelines, choose the multiprocessing configuration, and specify hardware mode as needed;
3. Initialize chosen multiprocessing mode;
4. Initialize frame rate and set frame-extend policy;
5. Create, configure, and open windows as required; and
6. Create and configure display channels as required.

Once the application program has created a graphical rendering environment by carrying out steps 1 through 6 above, then the application program typically iterates through the following main simulation loop once per frame:
7. Compute dynamics, update model matrices, etc.;
8. Delay until the next frame time;
9. Perform latency critical viewpoint updates; and
10. Draw a frame.

Alternatively, Open Scene Graph® may be used as another example of an appropriate rendering module. Open Scene Graph® operates in the same manner as OpenGL Performer®, providing programming tools written in C/C++ for a large variety of computer platforms. Open Scene Graph® is based on OpenGL® and is publicly available.

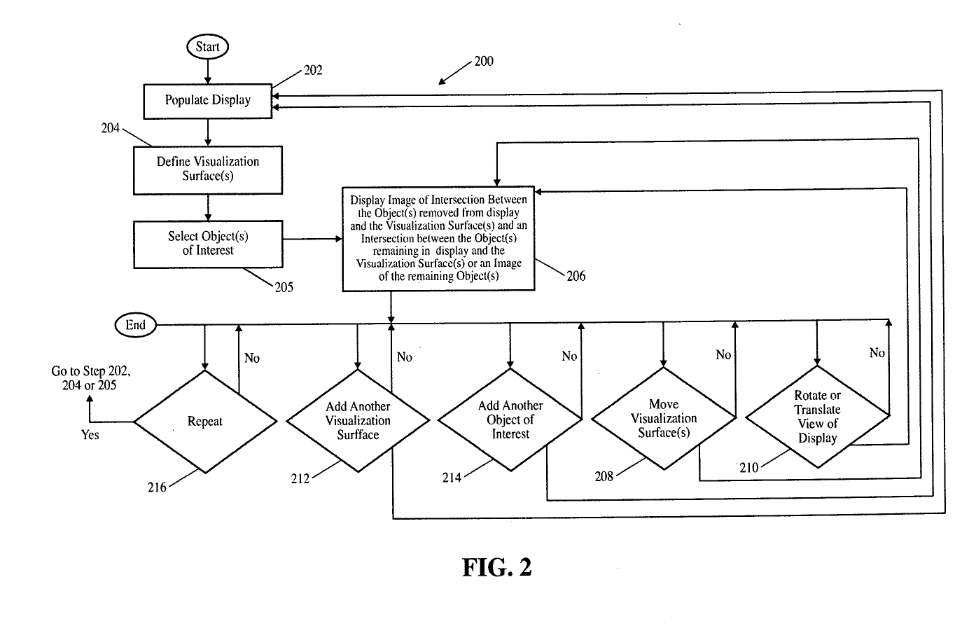

Overlaying the other elements of program 100 is visualization surface module 110. The visualization surface module 110 is configured to interact with three-dimensional data sets representing predetermined objects such as, for example, horizons and faults or three-dimensional point sets. In a manner generally well known in the art, the visualization surface module 110 interfaces with, and utilizes the functions carried out by, the rendering module 108, the basic graphics library 106, the menu/interface software 104 and the operating system 102. The visualization surface module 110 may be written in an object oriented programming language such as, for example, C++ to allow the creation and use of objects and object functionality. Methods enabled by the visualization surface module 110 are further described in reference to FIGS. 2 through 7.

The program 100 illustrated in FIG. 1 may be executed or implemented through the use of a computer system incorporating the program 100 and various hardware components. The system hardware components may include, for example, a processor, memory (e.g., random access memory and/or non-volatile memory devices), one or more input devices, one or more display devices, and one or more interface devices. These hardware components may be interconnected according to a variety of configurations and may include graphics cards like GeForce® marketed by NVIDIA® and processors manufactured by Intel® and/or AMD®. Non-volatile memory devices may include, for example, devices such as tape drives, semiconductor ROM or EEPROM. Input devices may include, for example, devices such as a keyboard, a mouse, a digitizing pad, a track ball, a touch-sensitive pad and/or a light pen. Display devices may include, for example, devices such as monitors, projectors and/or head-mounted displays. Interface devices may be configured to require digital image data from one or more acquisition devices and/or from one or more remote computers or storage devices through a network.

Any variety of acquisition devices may be used depending on the type of objects being imaged. The acquisition device(s) may sense various forms of mechanical energy (e.g., acoustic energy, displacement and/or stress/strain) and/or electromagnetic energy (e.g., light energy, radio wave energy, current and/or voltage).

A processor may be configured to reprogram instructions and/or data from RAM and/or non-volatile memory devices, and to store computational results into RAM and/or non-volatile memory devices. The computer-executable instructions direct the processor to operate on three-dimensional data sets and/or three-dimensional point sets based on the methods described herein.

In one embodiment, a three-dimensional volume data set may be stored in a format generally well known in the art. For example, the format for a particular data volume may include two parts: a volume header followed by the body of data that is as long as the size of the data set. The volume header typically includes information in a prescribed sequence, such as the file path (location) of the data set, size, dimensions in the x, y, and z directions, annotations for the x, y, and z axes, annotations for the data value, etc. The body of data is a binary sequence of bytes and may include one or more bytes per data value. For example, the first byte is the data value at volume location (0,0,0); the second byte is the data value at volume location (1,0,0); and the third byte is the data value at volume location (2,0,0). When the x dimension is exhausted, then the y dimension and the z dimension are incremented, respectively. This embodiment, however, is not limited in any way to a particular data format or data volume.

When a plurality of data volumes is used, the data value for each of the plurality of data volumes may represent a different physical parameter or attribute for the same geographic space. By way of example, a plurality of data volumes could include a geology volume, a temperature volume and a water-saturation volume. The voxels in the geology volume can be expressed in the form (x, y, z, seismic amplitude). The voxels in the temperature volume can be expressed in the form (x, y, z, ° C.). The voxels in the water-saturation volume can be expressed in the form (x, y, z, % saturation). The physical or geographic space defined by the voxels in each of these volumes is the same. However, for any specific spatial location (xo, yo, zo), the seismic amplitude would be contained in the geology volume, the temperature in the temperature volume and the water-saturation in the water-saturation volume.

The input data may be provided to the computer system through a variety of mechanisms. For example, the input data may be acquired into non-volatile memory and/or RAM using one or more interface devices. As another example, the input data may be supplied to the computer system through a memory medium such as a disk or a tape, which is loaded into/onto one of the non-volatile memory devices. In this case, the input data will have been previously recorded onto the memory medium. It is noted that the input data may not necessarily be raw sensor data obtained by an acquisition device. For example, the input data may be the result of one or more processing operations using a set of raw sensor data. The processing operation(s) may be performed by the computer system and/or one or more other computers.

Referring now to FIG. 2, one embodiment of a method 200 for implementing the present invention is illustrated.

In step 202, one or more three-dimensional data-objects may be selected to populate the scene on display using the GUI tools and menu/interface software 104 described in reference to FIG. 1. The selected data-objects are displayed for interpretation and/or analysis. Various techniques generally well known in the art and/or described in the '570 Patent may be used to create certain types of data-objects. Some three-dimensional data-objects are created from three-dimensional volume data sets comprising voxels. Voxel data is read from memory and converted into a specified color representing a specific texture. Textures are tiled into 254 pixel by 256 pixel images. This process is commonly referred to as sampling by those skilled in the art and may be coordinated among multiple CPU's on a per-tile basis. Other types of three-dimensional data-objects may represent an interpretation of a three-dimensional volume data-set or another three-dimensional data-object.

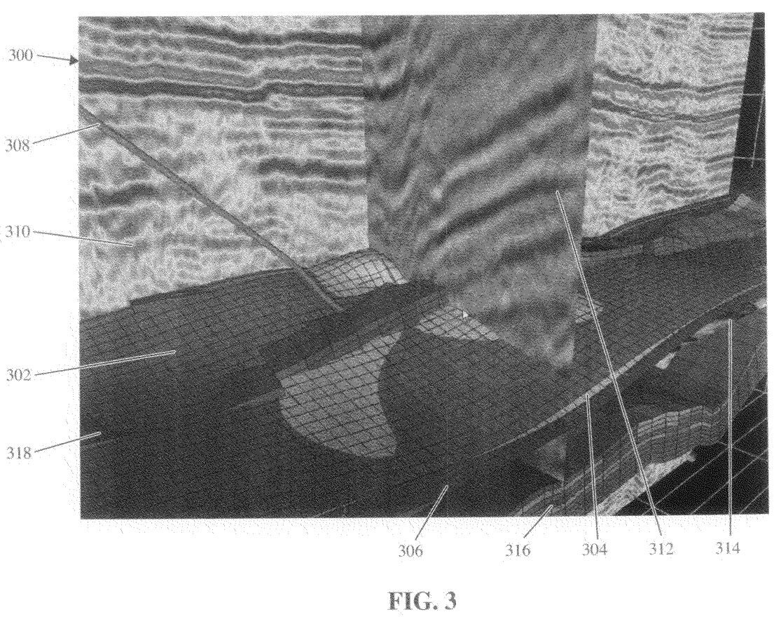

In FIG. 3, the results of step 202 are illustrated. The display 300 includes three-dimensional data-objects such as horizons 302, 304, 306, seismic-data slices 310, 312, 314, reservoir grids 316, 318 and a well path 308. It is noteworthy that, among other things, the horizon 302 and reservoir grid 318 appear to partially block the view of the well path 308, making the location of the well path 308 difficult to discern relative to the other objects in the display 300.

In step 204, at least one visualization surface is defined in the display using the GUI tools and menu/interface software 104 described in reference to FIG. 1. A visualization surface may be defined as any surface on which to display an image of an intersection with one or more objects removed from the display. A visualization surface may include, for example, any object within the display or any object to be added to the display. A visualization surface may also include, for example, any planar or non-planar object comprising three-dimensional seismic data or any other planar or non-planar object. A visualization surface may also be opaque or transparent—as determined by a default setting or using the GUI tools and menu/interface software 104 described in reference to FIG. 1. In either case, the visualization surface displays at least an image of an intersection between the visualization surface and one of the objects removed from the display.

The visualization surface(s) defined in step 204 may be implemented using various techniques generally well known in the art and may include, for example, clipping pings planes that essentially “clip” or remove the seismic data displayed outside of the visualization surface(s). One technique, for example, is described in U.S. Pat. No. 7,170,530, which is incorporated herein by reference. Another technique is described in U.S. Pat. No. 7,218,331, which is also incorporated herein by reference. Other techniques are described in “VR User Interface: Closed World Interaction” by Ching-Rong Lin and R. Bowen Loftin and “Interaction with Geoscience Data in an Immersive Environment” by Ching-Rong Lin, R. Bowen Loftin and H. Roice Nelson, Jr., which are incorporated herein by reference and include techniques for displaying an image of the contents of a bounding box as the bounding box is manipulated.

In step 205, at least one object of interest is selected from the display using the GUI tools and menu/interface software 104 described in reference to FIG. 1. An object of interest may be selected for display and analysis or for removal from the display. An object of interest could be selected, for example, based on its spatial relationship with another object in the display or predefined using other criteria to allow the selection of objects that do not share a single defining characteristic with another object in the display. Default settings could therefore, be set, for example, to automatically and simultaneously display only the selected object(s) of interest or to remove only the selected object(s) of interest. Thus, the object(s) of interest may be collectively selected on the basis that the object(s) is/are unnecessary to display and should be removed from the display to better analyze the remaining object(s) in the display.

In order to more fully analyze the remaining object(s) in the display relative to the object(s) selected for removal from the display, an image of an intersection between the object(s) removed from the display and the visualization surface(s) and an image of an intersection between the object(s) remaining in the display and the visualization surface(s) or an image of the remaining object(s) are displayed in step 206. The remaining object(s) in the display thus, may or may not intersect a visualization surface. This step illustrates the location of removed objects in the display by depicting their intersection with the visualization surface(s).

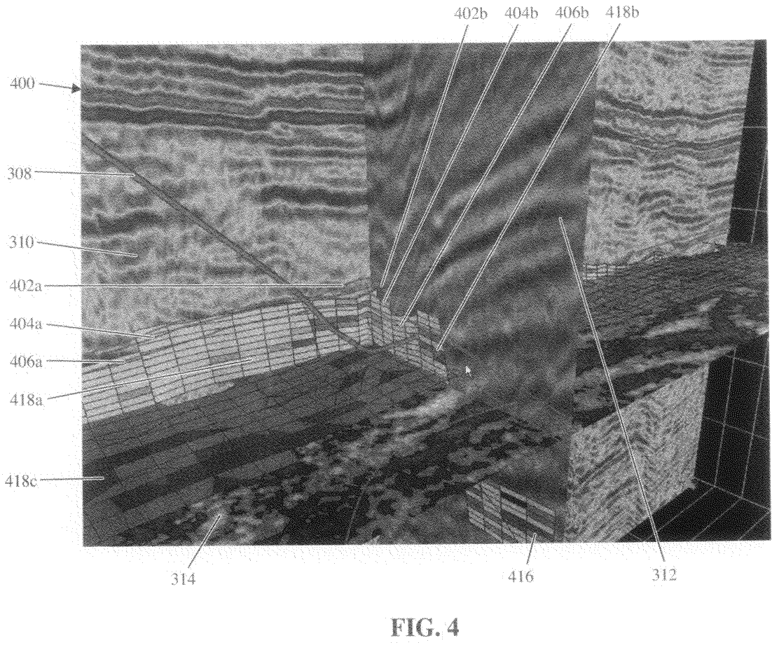

In FIG. 4, the results of step 206 are illustrated. The display 400 includes visualization surfaces 310, 312, 314, the remaining well path 308 and its intersection with the visualization surface 312. The display 400 also includes an image of an intersection between the horizons 302, 304, 306, which are removed from the display 400 and the visualization surfaces 310, 312. Horizon 302, for example, intersects visualization surfaces 310, 312 at 402a, 402b, respectively. Horizon 304 intersects visualization surfaces 310, 312 at 404a, 404b, respectively. And, horizon 306 intersects visualization surfaces 310, 312 at 406a, 406b, respectively. The display 400 further includes an image of an intersection between the reservoir grids 316, 318, which are removed from the display 400, and the visualization surfaces 310, 312 and 314. Reservoir grid 316, for example, intersects visualization surface 312 at 416. Likewise, reservoir grid 318 intersects visualization surfaces 310, 312, 314 at 418a, 418b, 418c, respectively. The entire well path 308 in front of the visualization surfaces 310 and 312 is now visible. The display 400 further highlights the positions of horizons 302, 304, 306 and reservoir grids 316, 318 relative to the well path 308. The display 400 may also be manipulated in various ways to adjust the view of the well path 308 and its surroundings.

As the image is displayed in step 206, several options described in reference to steps 208 through 216 may be interactively controlled through the GUI tools and menu/interface software 104 to reduce the amount of extraneous three-dimensional data-objects and analyze the remaining object(s) in the display.

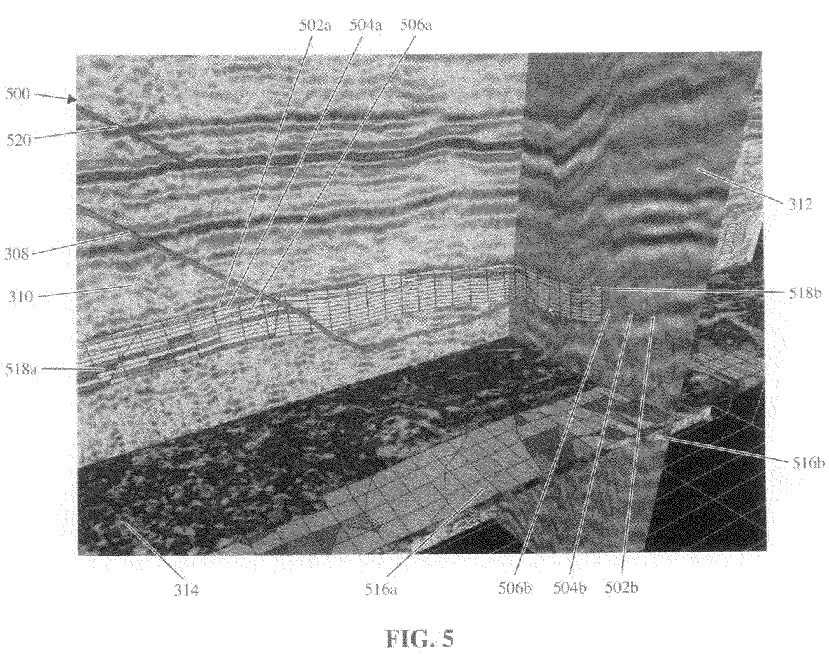

In step 208, the visualization surface(s) may be interactively moved within the display using the GUI tools and menu/interface software 104 described in reference to FIG. 1. As a visualization surface moves, the image of the intersection between the object(s) removed from the display and the visualization surface and the image of the intersection between the object(s) remaining in the display and the visualization surface or the remaining object(s) may be displayed. This step may be used to view fully displayed objects and the relative location of the object(s) removed from the display while a visualization surface is moved, which is illustrated by a comparison of the visualization surfaces 310, 312 and 314 in FIG. 4 and FIG. 5. Accordingly, step 206 is repeated, in real-time, to provide a new display as the visualization surface moves.

In step 210, the image displayed in step 206 may be interactively manipulated (rotated or zoomed (in/out)) using the GUI tools and menu/interface software 104 to view a different perspective of the image. As the image is rotated or zoomed, the image may be displayed. Accordingly, step 206 is repeated, in real-time, to provide a new display of a different perspective of the image.

In FIG. 5, compared to the display 400 in FIG. 4, the display 500 has been zoomed (out) to view a different perspective of the well path 308 relative to where each horizon 302, 304, and 306 intersects the visualization surfaces 310 and 312. Visualization surface 310, for example, intersects horizons 302, 304 and 306 at 502a, 504a and 506a, respectively. Visualization surface 312 intersects horizons 302, 304 and 306 at 502b, 504b and 506b, respectively. Because each visualization surface 310, 312 and 314 has been moved in the display 500, compared to the display 400 in FIG. 4, a different perspective of the well path 308 is illustrated relative to where each reservoir grid 316, 318 intersects a visualization surface 310, 312 or 314. Reservoir grid 316, for example, intersects visualization surfaces 314 and 312 at 516a and 516b, respectively. Likewise, reservoir grid 318 intersects visualization surfaces 310 and 312 at 518a and 518b, respectively. In addition, another well path 520 is visible.

In step 212, another visualization surface may be added to the display using the GUI tools and menu/interface software 104 described in reference to FIG. 1. Accordingly, step 202 is repeated to add a new visualization surface to the display.

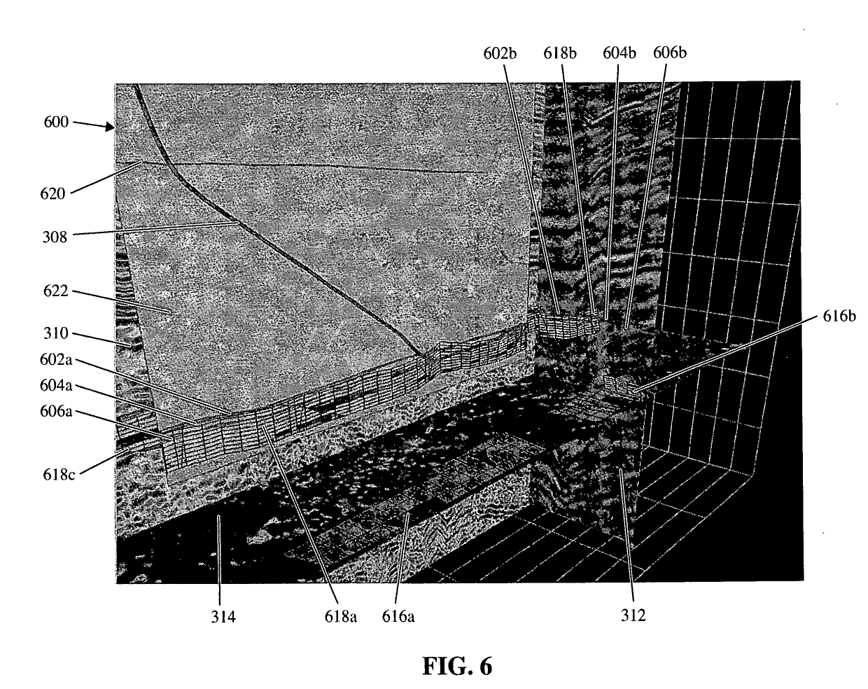

In FIG. 6, for example, the display 600 includes a new visualization surface 622, sometimes referred to as an opaque well section, that provides a different perspective of the display in FIG. 4. Alternatively, the visualization surface 622 may be transparent. Visualization surface 622 intersects horizons 302, 304 and 306 at 602a, 604a and 606a, respectively. Visualization surface 312 intersects horizons 302, 304 and 306 at 602b, 604b and 606b, respectively. Because each visualization surface 310, 312 and 314 has been moved in the display 600, compared to the display 400 in FIG. 4, a different perspective of the well path 308 is illustrated relative to where each reservoir grid 316, 318 intersects a visualization surface 310, 312 or 314. Reservoir grid 316, for example, intersects visualization surfaces 314 and 312 at 616a and 616b, respectively. Likewise, reservoir grid 318 intersects visualization surfaces 622, 312 and 310 at 618a, 618b and 618c, respectively. In addition, an intersection between the new visualization surface 622 and another horizon (not shown) is visible at 620. The visualization surface 622 may be manipulated in the same manner as the visualization surface(s) described in reference to steps 208 and 210.

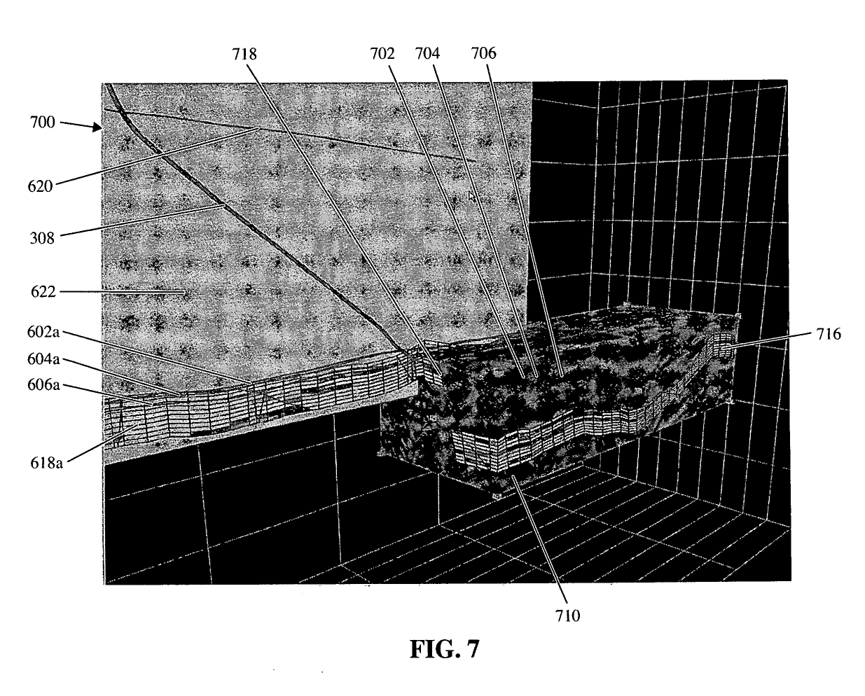

In FIG. 7, the display 700 includes another type of new visualization surface 710, sometimes referred to as a bounding box, that provides a different perspective of the display in FIG. 6. The visualization surface 710 may be opaque or transparent and may be manipulated in the same manner as the visualization surface(s) described in reference to steps 208 and 210. The visualization surface 710 essentially comprises six separate planar visualization surfaces although only three are actually displayed. Visualization surface 622 intersects horizons 302, 304 and 306 at 602a, 604a and 606a, respectively. Visualization surface 710 intersects horizons 302, 304 and 306 at 702, 704 and 706, respectively. Because each new visualization surface 622, 710 in the display 700 replaces the former visualization surfaces 310, 312 and 314 illustrated in FIG. 6, a different perspective of the well path 308 is illustrated relative to where each reservoir grid 316, 318 intersects a visualization surface 622 or 710. Reservoir grid 316, for example, intersects visualization surface 710 at 716. Likewise, reservoir grid 318 intersects visualization surfaces 622 and 710 at 618a and 718, respectively. The shape and size of the visualization surface 710, or any other visualization surface, may be interactively adjusted using the GUI tools and menu/interface software 104 described in reference to FIG. 1.

In step 214, another object may be added to the display using the GUI tools and menu/interface software 104 described in reference to FIG. 1. Accordingly, step 202 is repeated to add another object to the display.

In step 216, the method 200 may be repeated by repopulating the display at step 202, which may also include removing an object or visualization surface from the display. The method 200 may also be repeated by defining another visualization surface in the display at step 204 or by selecting another object of interest in the display at step 205.

Because the systems and methods described herein may be used to selectively and interactively analyze various three-dimensional data-objects, they may be particularly useful for analyzing three-dimensional medical data or geological data, however, may also find utility for analyzing and interpreting any other type of three-dimensional data-objects.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

1. A method for selectively imaging one or more objects in a display, which comprises:
defining a visualization surface within the display;
selecting an object of interest from a plurality of objects within the display; and
displaying only an image of an intersection between at least one of the plurality of objects removed from the display and the visualization surface and an image of the object(s) remaining in the display or an image of an intersection between the remaining object(s) and the visualization surface.

2. The method of claim 1 wherein the visualization surface is a well section.

3. The method of claim 1 wherein the visualization surface intersects the remaining object(s).

4. The method of claim 1 wherein the remaining object(s) include at least one well path, the visualization surface intersecting the well path along a length of the well path.

5. The method of claim 1 wherein the plurality of objects comprises at least one object that is an interpretation of three-dimensional data.

6. The method of claim 1 further comprising:
moving the visualization surface within the display; and
displaying only an image of an intersection between at least one of the plurality of objects removed from the display and the visualization surface and an image of the object(s) remaining in the display or an image of an intersection between the remaining object(s) and the visualization surface, as the visualization surface is moved.

7. The method of claim 1 further comprising rotating or translating the display to view a different perspective of the image of the intersection between the at least one of the plurality of objects removed from the display and the visualization surface and the image of the object(s) remaining in the display or the image of the intersection between the remaining object(s) and the visualization surface.

8. The method of claim 1 further comprising:
defining another visualization surface within the display; and
displaying only an image of an intersection between at least one of the plurality of objects removed from the display and the another visualization surface and an image of the object(s) remaining in the display or an image of an intersection between the remaining object(s) and the another visualization surface.

9. The method of claim 1 further comprising:
selecting another object of interest from the plurality of objects within the display; and
displaying only an image of an intersection between at least one of the plurality of objects removed from the display and the visualization surface and an image of the object(s) remaining in the display or an image of an intersection between the remaining object(s) and the visualization surface.

10. The method of claim 1 wherein displaying the image comprises simultaneously removing at least two of the plurality of objects from the display.

11. A computer-readable medium having computer executable instructions for selectively imaging one or more objects in a display, the instructions being executable to implement:
defining a visualization surface within the display;
selecting an object of interest from a plurality of objects within the display; and
displaying only an image of an intersection between at least one of the plurality of objects removed from the display and the visualization surface and an image of the object(s) remaining in the display or an image of an intersection between the remaining object(s) and the visualization surface.

12. The computer-readable medium of claim 11 wherein the visualization surface is a well section.

13. The computer-readable medium of claim 11 wherein the visualization surface intersects the remaining object(s).

14. The computer-readable medium of claim 11 wherein the remaining object(s) include at least one well path, the visualization surface intersecting the well path along a length of the well path.

15. The computer-readable medium of claim 11 wherein the plurality of objects comprises at least one object that is an interpretation of three-dimensional data.

16. The computer-readable medium of claim 11 further comprising:
moving the visualization surface within the display; and
displaying only an image of an intersection between at least one of the plurality of objects removed from the display and the visualization surface and an image of the object(s) remaining in the display or an image of an intersection between the remaining object(s) and the visualization surface, as the visualization surface is moved.

17. The computer-readable medium of claim 11 further comprising rotating or translating the display to view a different perspective of the image of the intersection between the at least one of the plurality of objects removed from the display and the visualization surface and the image of the object(s) remaining in the display or the image of the intersection between the remaining object(s) and the visualization surface.

18. The computer-readable medium of claim 11 further comprising:
defining another visualization surface within the display; and
displaying only an image of an intersection between at least one of the plurality of objects removed from the display and the another visualization surface and an image of the object(s) remaining in the display or an image of an intersection between the remaining object(s) and the another visualization surface.

19. The computer-readable medium of claim 11 further comprising:
selecting another object of interest from the plurality of objects within the display; and
displaying only an image of an intersection between at least one of the plurality of objects removed from the display and the visualization surface and an image of the object(s) remaining in the display or an image of an intersection between the remaining object(s) and the visualization surface.

20. The computer-readable medium of claim 11 wherein displaying the image comprises simultaneously removing at least two of the plurality of objects from the display.

21. A method for selectively imaging one or more objects in a display, which comprises:
defining a visualization surface within the display;
selecting an object of interest from a plurality of objects within the display, at least one of the plurality of objects comprising a reservoir grid; and
displaying an image of an intersection between the reservoir grid and the visualization surface and an image of the object(s) remaining in the display or an image of an intersection between the remaining object(s) and the visualization surface.

22. The method of claim 21 wherein the visualization surface is a well section.

23. The method of claim 21 wherein the visualization surface intersects the remaining object(s).

24. The method of claim 21 wherein the remaining object(s) include at least one well path, the visualization surface intersecting the well path along a length of the well path.

25. The method of claim 21 wherein the plurality of objects comprises at least one object that is an interpretation of three-dimensional data.

26. The method of claim 21 further comprising:
moving the visualization surface within the display; and
displaying an image of an intersection between the reservoir grid and the visualization surface and an image of the object(s) remaining in the display or an image of an intersection between the remaining object(s) and the visualization surface, as the visualization surface is moved.

27. The method of claim 21 further comprising rotating or translating the display to view a different perspective of the image of the intersection between the reservoir grid and the visualization surface and the image of the object(s) remaining in the display or the image of the intersection between the remaining object(s) and the visualization surface.

28. The method of claim 21 further comprising:
defining another visualization surface within the display; and
displaying an image of an intersection between the reservoir grid and the another visualization surface and an image of the object(s) remaining in the display or an image of an intersection between the remaining object(s) and the another visualization surface.

29. The method of claim 21 further comprising:
selecting another object of interest from the plurality of objects within the display; and
displaying an image of an intersection between the reservoir grid and the visualization surface and an image of the object(s) remaining in the display or an image of an intersection between the remaining object(s) and the visualization surface.

30. The method of claim 21 wherein displaying the image comprises simultaneously removing at least two of the plurality of objects from the display.

31. A computer-readable medium having computer executable instructions for selectively imaging one or more objects in a display, the instructions being executable to implement:
defining a visualization surface within the display;
selecting an object of interest from a plurality of objects within the display; and
displaying only an image of an intersection between at least one of the plurality of objects and the visualization surface and an image of the object(s) remaining in the display or an image of an intersection between the remaining object(s) and the visualization surface.

32. The computer-readable medium of claim 31 wherein the visualization surface is a well section, the visualization surface comprising a planar surface or a non-planar surface.

33. The computer-readable medium of claim 31 wherein the visualization surface intersects the remaining object(s).

34. The computer-readable medium of claim 31 wherein the remaining object(s) include at least one well path, the visualization surface intersecting the well path along a length of the well path.

35. The computer-readable medium of claim 31 wherein the plurality of objects comprises at least one object that is an interpretation of three-dimensional data.

36. The computer-readable medium of claim 31 further comprising:
moving the visualization surface within the display; and
displaying an image of an intersection between the reservoir grid and the visualization surface and an image of the object(s) remaining in the display or an image of an intersection between the remaining object(s) and the visualization surface, as the visualization surface is moved.

37. The computer-readable medium of claim 31 further comprising rotating or translating the display to view a different perspective of the image of the intersection between the reservoir grid and the visualization surface and the image of the object(s) remaining in the display or the image of the intersection between the remaining object(s) and the visualization surface.

38. The computer-readable medium of claim 31 further comprising:
defining another visualization surface within the display; and
displaying an image of an intersection between the reservoir grid and the another visualization surface and an image of the object(s) remaining in the display or an image of an intersection between the remaining object(s) and the another visualization surface.

39. The computer-readable medium of claim 31 further comprising:
selecting another object of interest from the plurality of objects within the display; and
displaying an image of an intersection between the reservoir grid and the visualization surface and an image of the object(s) remaining in the display or an image of an intersection between the remaining object(s) and the visualization surface.

40. The computer-readable medium of claim 31 wherein displaying the image comprises simultaneously removing at least two of the plurality of objects from the display.

41. A platform for selectively imaging one or more objects in a display that is embodied on one or more computer readable media and executable on a computer, said platform comprising:
a user input module for accepting user inputs related to defining a visualization surface within the display and selecting an object of interest from a plurality of objects within the display;
a visualization surface module for processing a set of instructions to determine an intersection between at least one of the plurality of objects removed from the display and the visualization surface and an intersection between the object(s) remaining in the display and the visualization surface; and
a rendering module for displaying only an image of an intersection between the at least one of the plurality of objects removed from the display and the visualization surface and an image of the object(s) remaining in the display or an image of an intersection between the remaining object(s) and the visualization surface.

42. A platform for selectively imaging one or more objects in a display that is embodied on one or more computer readable media and executable on a computer, said platform comprising:
a user input module for accepting user inputs related to defining a visualization surface within the display and selecting an object of interest from a plurality of objects within the display, at least one of the plurality of objects comprising a reservoir grid;
a visualization surface module for processing a set of instructions to determine an intersection between the reservoir grid and the visualization surface and an intersection between the object(s) remaining in the display and the visualization surface; and
a rendering module for displaying an image of an intersection between the reservoir grid and the visualization surface and an image of the object(s) remaining in the display or an image of an intersection between the remaining object(s) and the visualization surface.
